(19) United States
(12) Patent Application Publication
(10) Pub. No.: US 2014/0000527 A1
(43) Pub. Date: Jan. 2, 2014

(54) ANIMAL CONFINEMENT HOUSING CONFIGURED FOR IMPROVED FORCED AIR VENTILATION

(71) Applicant: Shan MARTIN, Canton, MS (US)

(72) Inventor: Shan MARTIN, Canton, MS (US)

(21) Appl. No.: 13/974,355

(22) Filed: Aug. 23, 2013

Related U.S. Application Data
(63) Continuation of application No. 13/040,803, filed on Mar. 4, 2011.
(60) Provisional application No. 61/310,866, filed on Mar. 5, 2010.

(51) Int. Cl. A01K 1/00; E04B 7/16; F24F 11/00

(52) U.S. Cl. CPC A01K 1/0052; F24F 11/001; E04B 7/16; A01K 1/0058
USPC 119/448; 52/1; 52/66

(57) ABSTRACT

An animal confinement housing includes an air intake section and an animal confinement section. Air is drawn into the housing through the air intake section and directed through the confinement section to ventilate the confinement section and the animals confined therein. The height of the confinement section can be selectively varied between a raised position of sufficient height to permit personnel and equipment to enter the confinement section and a lowered position that is of sufficient height to accommodate the animals confined therein by reduces the cross-sectional area through the confinement section to increase the air flow rate through the confinement section, without requiring an increase in the rate of intake of air into the air intake section.

### CROSS-REFERENCE TO RELATED APPLICATIONS

This application is a continuation application which claims priority under 35 USC §120 to U.S. application Ser. No. 13/040,803 filed Mar. 4, 2011, which claims the benefit under 35 U.S.C. §119(e) of U.S. Provisional Application No. 61/310,866, filed Mar. 5, 2010, the respective disclosures of which are hereby incorporated by reference.

### FIELD OF THE INVENTION

The present invention is directed to animal confinement housings, and, in particular, housings adapted to hold poultry and configurable to improve air ventilation through the housing.

### BACKGROUND OF INVENTION

An important requirement of large scale livestock production, such as, poultry (e.g., chicken or turkeys), cattle, hogs, etc., is providing adequate ventilation through the animal confinement structure(s). For example, in poultry raising operations in which the birds are housed in crowded conditions, air flow through the confinement structure at a relatively high rate is required to remove excess heat generated by birds being packed closely together. The air flow may be generated by fans drawing or pushing air through the building, and the air may be drawn through “wet panels” consisting of fabric through which water constantly flows to further cool the air before it is directed through the confinement structure.

In fact, the amount of ventilation within the confinement structure, as defined by the air flow rate through the structure, can be correlated to the maximum weight to which birds housed in the structure can be grown. For example, in conventional chicken structures, typically having an airflow rate of about 450 feet/minute through the building, the maximum consistently achievable weight per bird is approximately 8 lbs. An ideal weight per bird, however, is about 9 lbs, but this weight gain cannot be effectively maintained in crowded conditions within conventional confinement structures. To maintain a weight of 9 lbs per bird in crowded conditions will require significantly higher air flow (e.g., up to 1000 feet/minute) to maintain adequate ventilation within the structure.

To achieve 1000 feet/min air flow through the confinement structure would require significantly more powerful fans and greater intake rate. The more powerful fans increase expenses, both initial expenses in the cost of the fans themselves and operational expenses in the form of greater energy costs. Moreover, the greater air intake would actually draw water out of the wet panels, thereby resulting in a wet air flow through the animal confinement structure.

### SUMMARY OF THE INVENTION

Aspects of the invention are embodied in a housing for holding livestock which comprises an air intake section, one or more intake fans, and an animal confinement section. The air intake section has a height and a width defining a transverse, interior cross-sectional space. The one or more air intake fans are configured to draw air into said air intake section. The animal confinement section has an intake end and an exhaust end and is connected to the air intake section so that air drawn into the air intake section by the one or more fans flows through the animal confinement section from the intake end to the exhaust end. The animal confinement section has a width and a height defining a transverse, interior cross-sectional space, and the animal confinement section is configured such that the height thereof may be varied between a first height and a second height. The first height, together with the width of the animal confinement section, defines a first interior cross-sectional space, and the second height, together with the width of the said animal confinement section, defines a second interior cross-sectional space. The second height is smaller than the first height, so that the cross-sectional area of the second interior cross-sectional space is less than the cross-sectional area of the first interior cross-sectional space and is less than the cross-sectional area of the interior cross-sectional space of said air intake section.

Accordingly, the air flow rate through the confinement section will increase when changing the height from the first height to the second height without requiring that the rate of air intake through the intake section be increased.

These and other features, aspects, and advantages of the present invention will become apparent to those skilled in the art after considering the following detailed description, appended claims and accompanying drawings.

### BRIEF DESCRIPTION OF THE DRAWINGS

FIG. 1 is a perspective view of an animal confinement housing embodying aspects of the present invention showing a configurable confinement section in both a raised and lowered position.

FIG. 2 is a partial perspective view of the animal confinement housing showing an end of the housing comprising a fixed height air intake section.

FIG. 3 is a partial perspective view of the animal confinement housing showing the fixed height air intake section and the adjustable height confinement section in a raised position.

FIG. 4 is a partial perspective view showing an exhaust end of the variable height confinement section.

FIG. 5 is a partial side view of the animal confinement housing showing the fixed height air intake section and the variable height confinement section in a lowered position.

FIG. 6 is a partial side view of the animal confinement housing showing the fixed height air intake section and the variable height confinement section in a raised position.

FIG. 7A is an end cross-sectional view along the line 7A-7A in FIG. 5.

FIG. 7B is a cross-sectional view along the line 7B-7B in FIG. 6.

FIG. 8 is a partial cross-sectional view of the structure shown in FIG. 7A.

FIG. 9A is an alternate embodiment of the structure shown in FIG. 7A.

FIG. 9B shows additional details of the embodiment of FIG. 9a.

FIG. 10 is an isometric view of a gull-wing panel adapted for constructing walls and the roof of the housing.

FIG. 11 is a partial perspective view of a lower beam of a side curtain wall of the confinement section of the housing with a gull-wing panel secured thereto.

FIG. 12 is a perspective view of the lower beam of the side curtain wall of the housing.

FIG. 13 is a partial perspective view of the roof of the housing formed from gull-wing panels.

FIG. 14 is a schematic side view of an assembly for connecting a hydraulic jack to the roof and curtain wall of the housing.

FIG. 15 is a schematic perspective view of pole guide support.

### DETAILED DESCRIPTION OF THE INVENTION

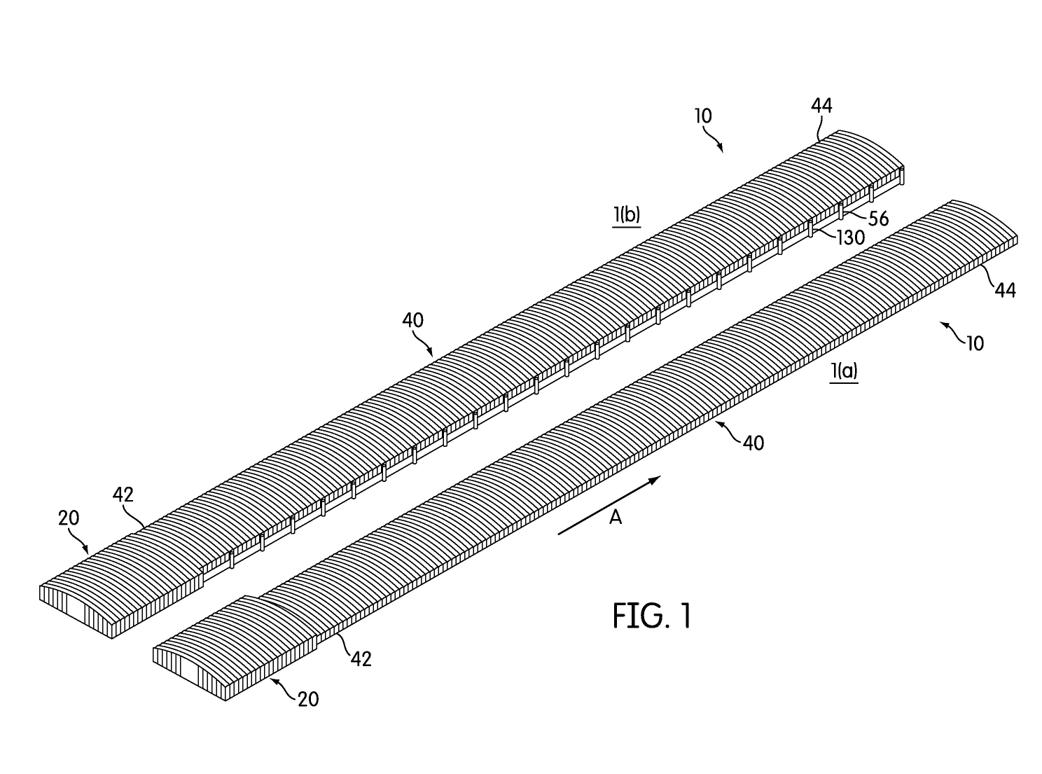

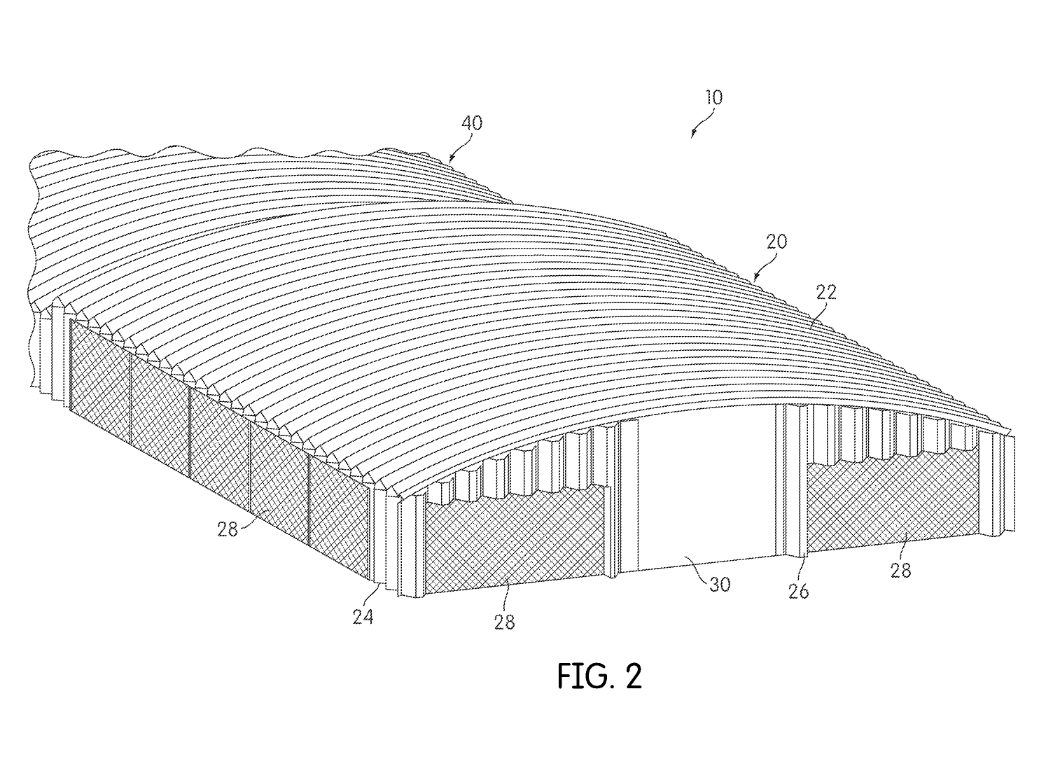

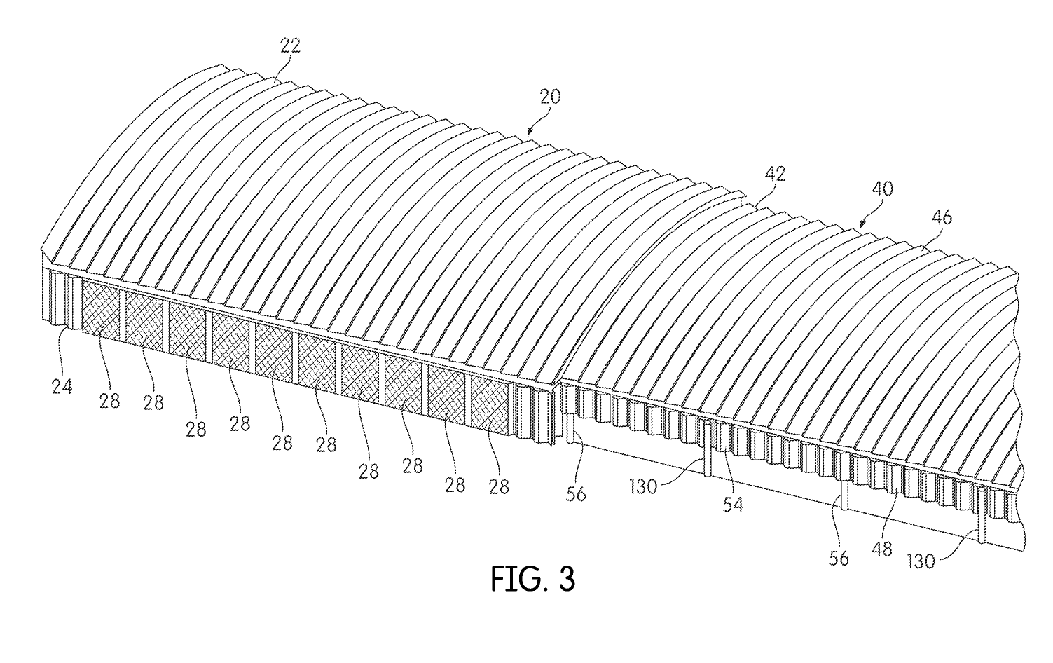

A confinement housing for animals, e.g., livestock, embodying aspects of the present invention is represented by reference number 10 in FIGS. 1-6. The housing 10 comprises a two-part building; namely a fixed air intake section 20 at one end and an elongated variable height animal confinement section 40 extending from the intake section 20.

The intake section 20 includes side walls 24 and an end wall 26 supporting a roof 22. By way of example, and not intended to be limiting, the intake section 20 may have area dimensions of 44 feet wide×40 feet long with a 10 foot high eave. A plurality of wet panels 28, which in one embodiment, comprise fabric through which water constantly flows, may be provided in the side walls and/or the end wall 26. An opening, such as door opening 30, may be provided in the end wall 26 to permit the ingress and egress of people and machinery to and from the intake section 20. Doors, shutters, or louvers (not shown) may be provided in conjunction with the wet panels 28 for selectively controlling air flow through each wet panel 28. Operation of such devices for controlling air flow through the wet panels may be automated, with actuators for opening and closing the devices under microprocessor control within a servo control loop system coupled to sensors for measuring parameters within the confinement section 20, such as airflow rate, temperature, and humidity.

The roofs and walls of the intake section 20 may be formed from suitable framing material covered with a suitable sheeting material, such as corrugated metal. A framing structure assembly that minimizes internal beams and posts is preferred so as to provide a relatively unobstructed airflow path into and through the intake section 20 and also to limit obstructions to people and equipment moving in the section 20.

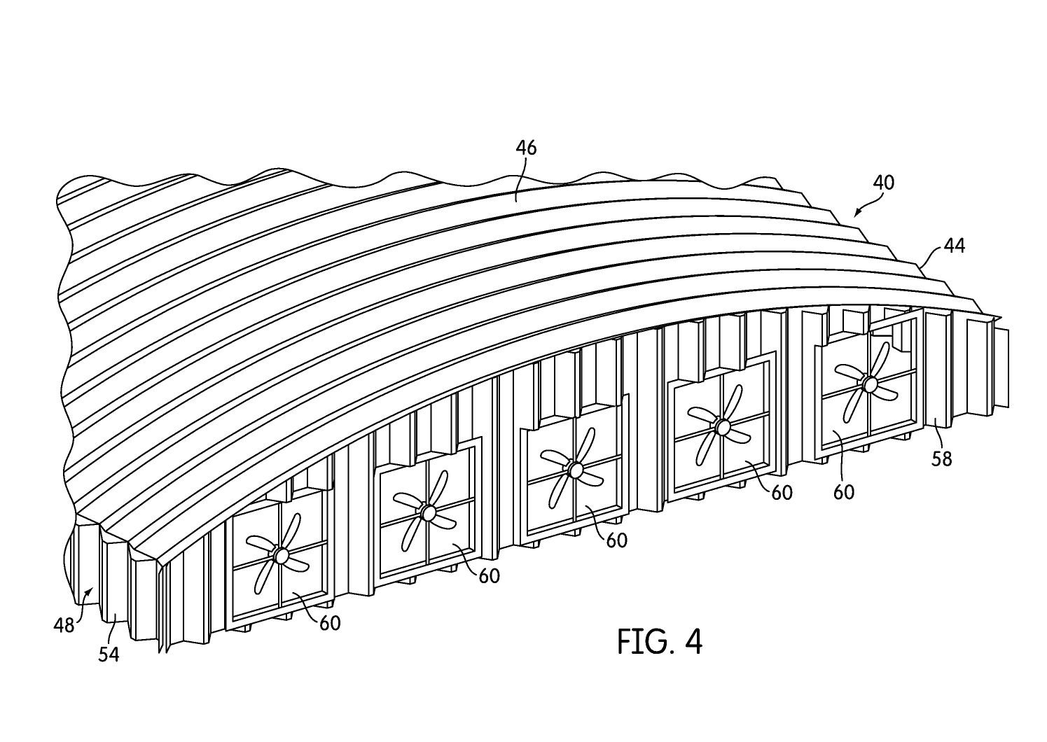

The confinement section 40 is an elongated, tube-like structure preferably having a smaller width than the intake section 40 and a length several times that of the intake section 40. For example, the confinement section may be 40 feet wide and up to 300 to 400 feet long. The livestock animals are housed within the confinement section 40 (in some applications, animals may also be housed in the intake section 20). The confinement section 40 includes side walls 48, an end wall 58, and a roof 46 and extends from a proximal end 42, which is the intake for air from the intake section 20, to a remote end 44 at which air from the confinement section 40 is exhausted. As shown in FIG. 4, fans 60 (e.g., five) are provided in the end wall 58 at the remote end 44 of the confinement section 40 for drawing air into the intake section 20 and through the confinement section 40, in the direction of arrow “A” in FIG. 1. Operation of the fans 60 may also be under automated, microprocessor control within the servo control loop system coupled to sensors for measuring parameters within the confinement section 40, such as airflow rate, temperature, and humidity.

In one embodiment, the confinement section 40 includes six fans—four fans rated at 33,000 cfm and two fans rated at 18,000 cfm. The two small fans may serve as a back up to one of the larger fans, should one of the larger fans malfunction. In addition, the smaller fans may be operated in lieu of one or more of the larger fans during times at which lower airflow rates are required through the confinement section 40. For example during the brooding phase of raising young chicks, which do not generate the heat that larger birds generate and cannot tolerate the cooler temperatures generated by high airflow rates, the smaller fans my be employed to generated relatively lower air flows. Sufficient air flow may be generated by operating the fan intermittently, on a timed basis, e.g., one out of every five minutes.

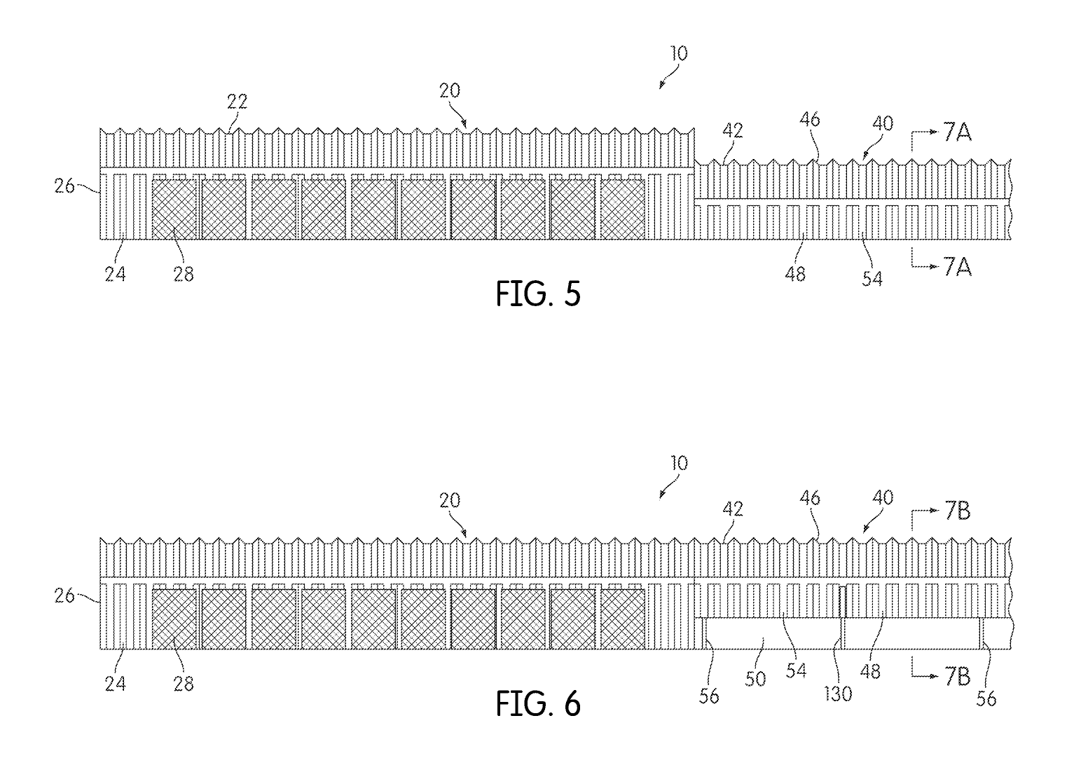

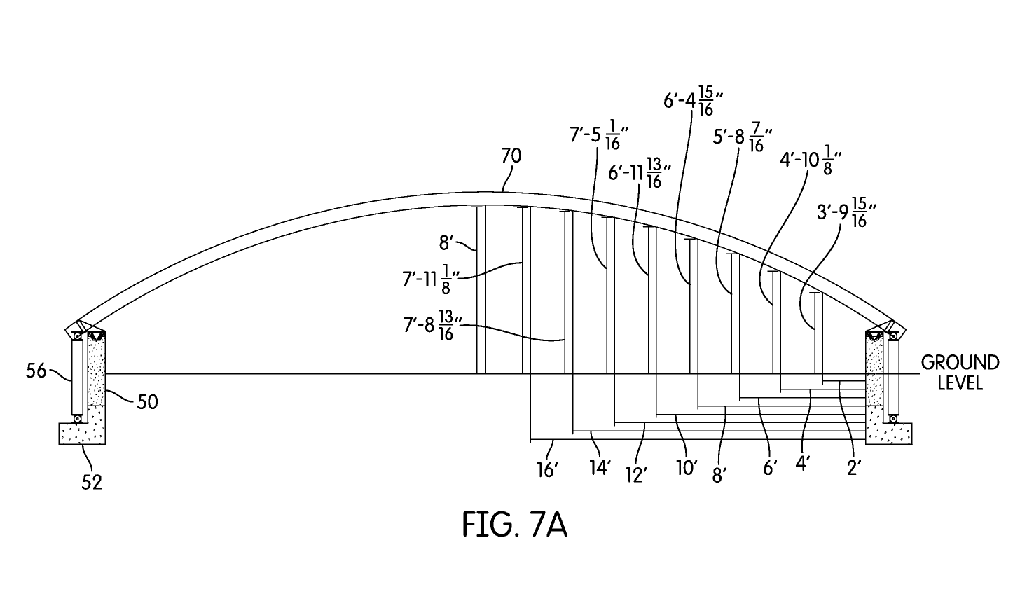

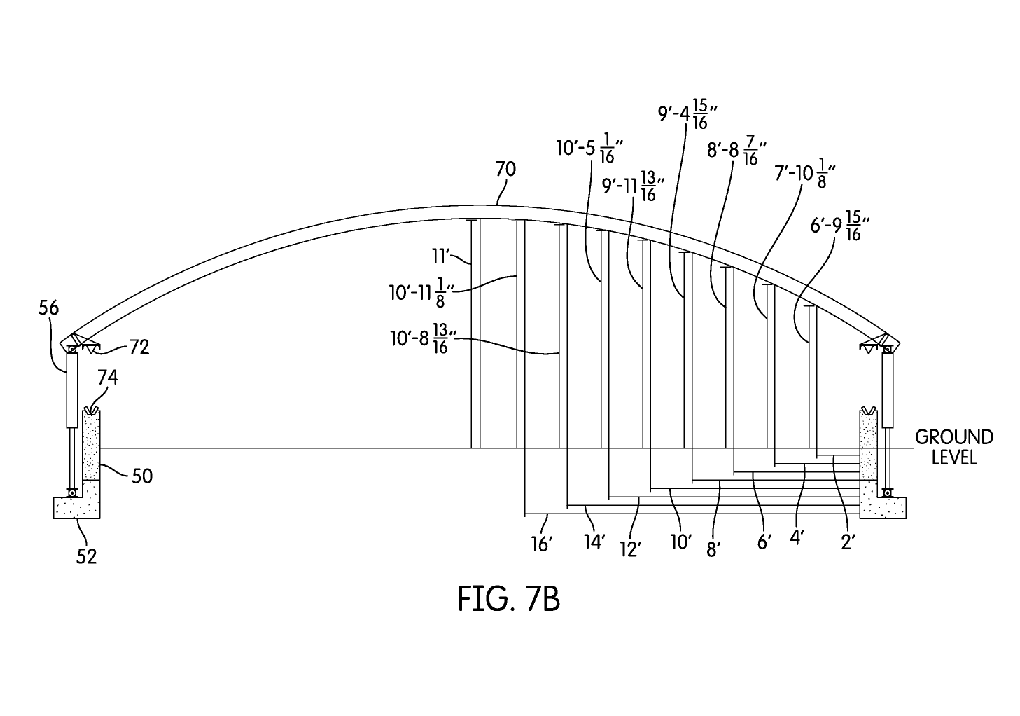

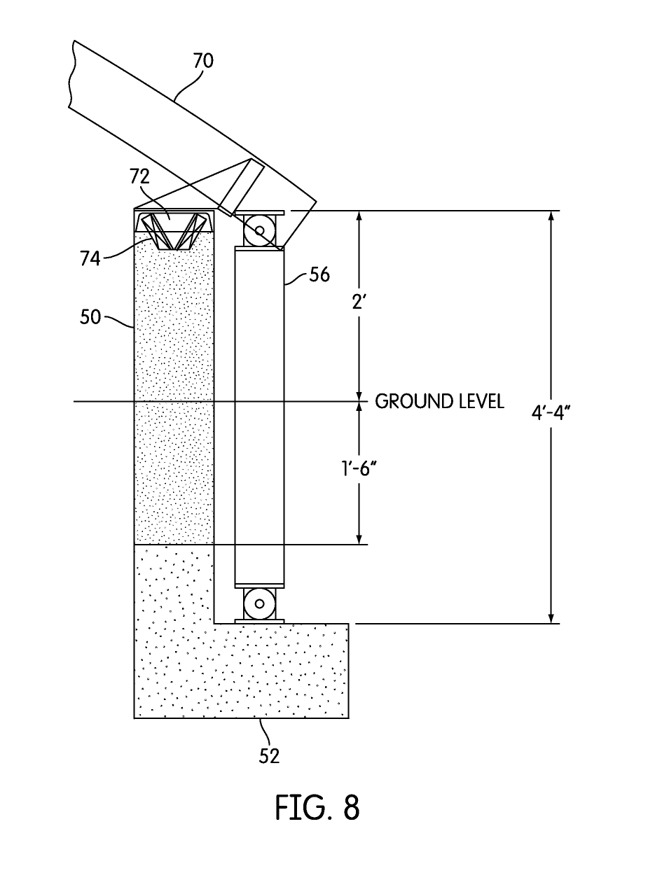

As shown in FIGS. 7A, 7B, and 8, the side walls 48 of the confinement section 40 includes a perimeter wall 50, preferably made of concrete, supported on a concrete footing 52. Outside the concrete perimeter wall 50 there is a short curtain wall 54, comprising, e.g., corrugated metal, that is suspended at its upper edge from the eaves of the curved roof 46 (See FIGS. 5 and 6). Dimensions shown in FIG. 8 illustrate a suitable height for the perimeter wall 50 and a suitable height of the wall 50 above ground level, but are not intended to be limiting.

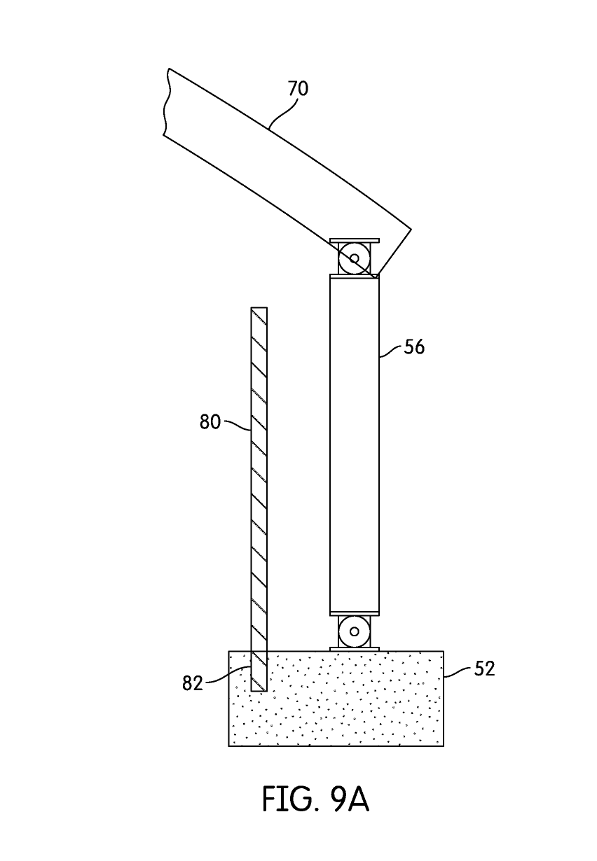

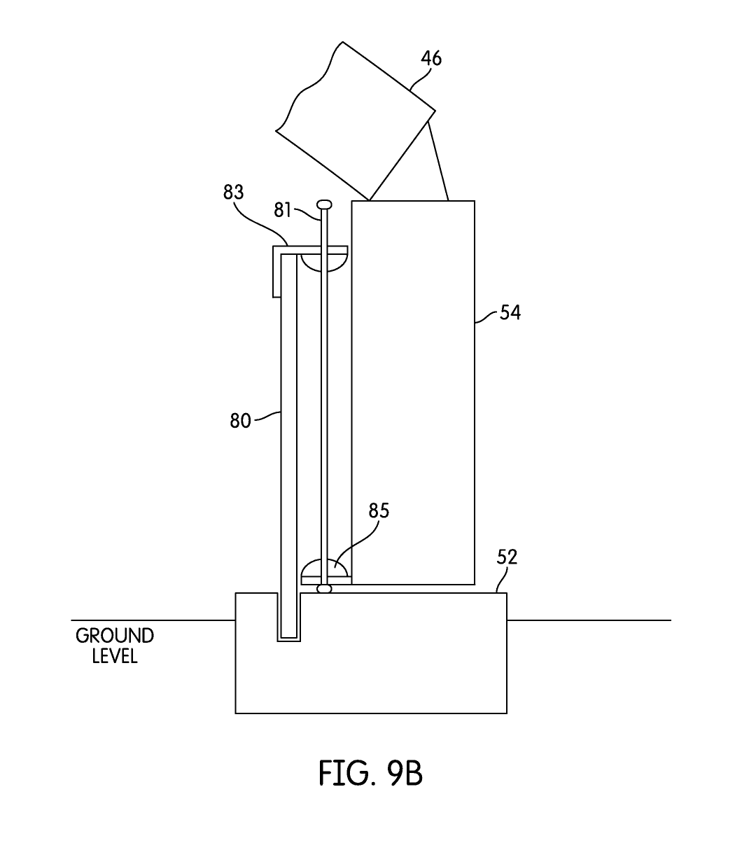

An alternative embodiment is shown in FIG. 9a. In FIG. 9a, concrete perimeter wall 50 is replaced by interior wall 80 which is secured to and at least partially supported by the footing 52. Wall 80 may comprise a thin, relatively rigid panel material, such as plywood, PVC, or Plexiglas, and may be secured with respect to the footing 52 by inserting the panel material into a groove 82 formed in the top of the footing 52. Note that curtain wall 54 is omitted from FIG. 9a for clarity.

FIG. 9b shows further details of the embodiment shown in FIG. 9a. An upper L-bracket 83 is secured to the top of interior wall 80, and extends the length of the interior wall 80 with one flange thereof extending horizontally outwardly toward the curtain wall 54. A lower L-bracket 85 is secured to a lower end of the curtain wall 54, and extends the length of the curtain wall with one flange thereof extending horizontally inwardly toward the interior wall 80. A guide rod 81 is secured to the lower bracket 85 (e.g., by threading the lower end of the guide rod 81 to the horizontal flange of the lower bracket 85) and extends upwardly through a clearance hole formed in the horizontal flange of the upper bracket 83. The guide rod 81 provides lateral support for the interior wall 80. In addition, a sealant material (e.g., foam rubber) is secure to the upper surface of the horizontal flange of the lower bracket 85 and/or to the bottom surface of the horizontal flange of the upper bracket 83 so that when the roof 46 and curtain wall 54 are in their uppermost positions and the respective horizontal flanges of the upper bracket 83 and lower bracket 85 contact each other, the sealant material provides a seal between the curtain wall 54 and the interior wall 80.

In one embodiment, the roof frame structure assembly comprises a plurality of arched beams 70 spanning the confinement section 40. The radius of curvature will depend on the width of the building and the desire height of the ceiling. Dimensions shown in FIGS. 7A and 7B illustrate a suitable curvature for the beams 70 (and roof), but are not intended to be limiting. V-channel beams 72 extend lengthwise of the roof 46 and are connected to each of the arched beams 70 proximate the opposite ends of each beam 70. The v-channel beams 72 include a v-shaped, downwardly-projecting block that is received in a v-shaped groove 74 formed in the top of the perimeter walls 50 when the roof 46 is supported on the perimeter wall 50. The entire roof 46 has an exterior of corrugated metal in an arched shape to give it rigidity. The inside of the roof, i.e., the ceiling of the confinement section 40, may be covered with a layer of insulation having a smooth plastic membrane interior surface. Other types of insulations may be used, or, in some applications, the insulation may be omitted if not necessary to maintain desired temperature within the section 40.

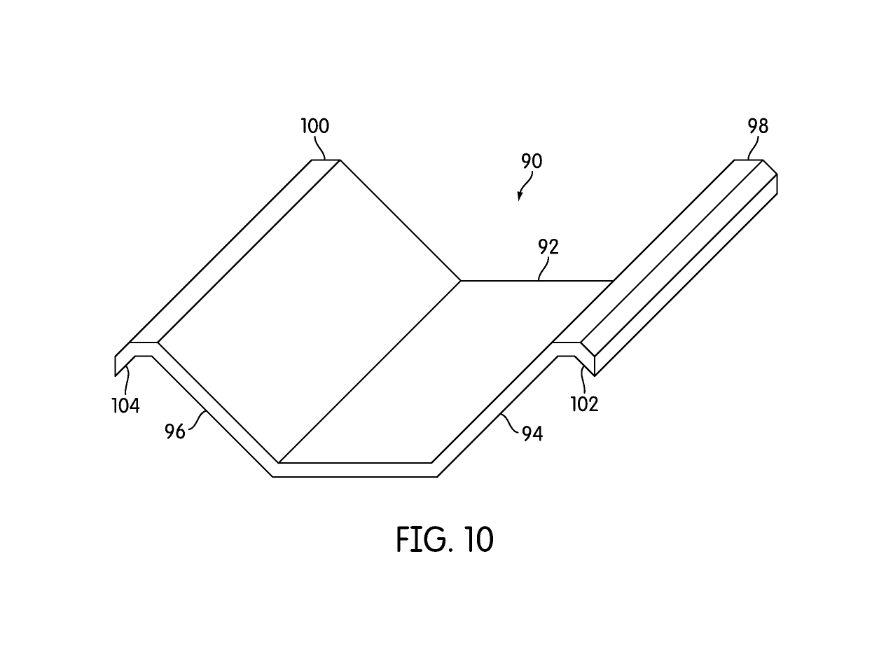

Details of an embodiment of the curtain wall 54 of the confinement section 40 are shown in FIGS. 10-12. The curtain wall of this embodiment comprises top and bottom beams 110 between which extend angled panels 90—referred to herein as gull-wing panels—which are connected at their opposite longitudinal ends to the top and bottom beams 110. Details of the gull-wing panel 90 are shown in FIG. 10. Each gull-wing panel 90 comprises a generally flat trough 92 extending longitudinally of the panel 90 with opposed, upwardly angled sides 94, 96 terminating in generally flat peaks 98, 100, each having a width dimension smaller than the width dimension of the trough 92, and depending flanges 102, 104 extending downwardly from the peaks 98, 100, respectively, at roughly the same angular orientation as the sides 94, 96 and defining the longitudinal edges of the panel 90. Adjacent gull-wing panels 90 are secured to one another by means of suitable fasteners extending through their respective, overlapping flat peaks 98, 100. Suitable fasteners include rivets or bolts with bolt head gasket washers and lock nuts.

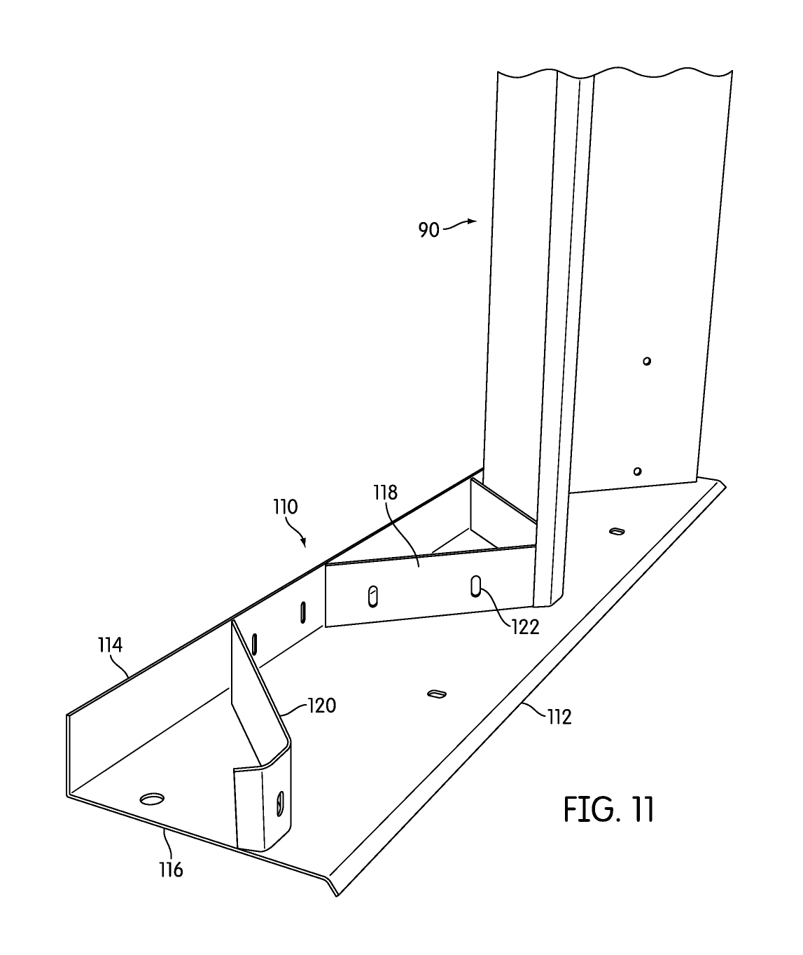

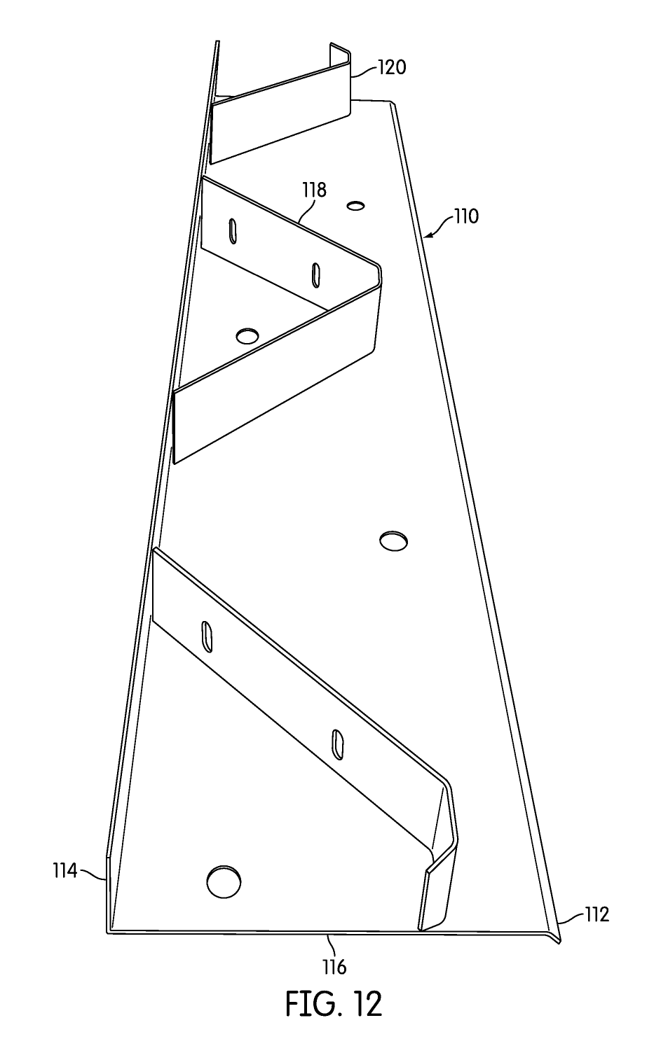

Details of a lower beam 110 are shown in FIGS. 11 and 12. The beam 110 is elongated in its longitudinal dimension with a web portion 116, a generally right angled flange 114 and stiffening flange 112 that is generally shorter than the flange 114 and extends from the web portion 116. Panel connecting flanges 118, 120 are secured to the web portion 116 and the flange 114, for example by welding. Panel connecting flanges have shapes generally conforming to the shape of the panels 90 and include fastener holes 122 which align with corresponding faster holes formed in the ends of the panels 90 and through which suitable fasteners can be inserted for connecting the panel 90 to the flanges 118 and 120 and thus to the beam 110. Suitable fasteners include rivets or bolts with bolt head gasket washers and lock nuts. Note that fastener holes 122 formed in the panel connecting flanges 118, 120 are elongated, thereby facilitating alignment between the panel fastener holes and the connecting flange fastener holes.

Beams 110 are secured to the opposed ends of the panels 90 in the manner shown to form the side walls of the confinement section 40. A bottom panel 110 is shown in FIGS. 11 and 12; a top panel would be inverted.

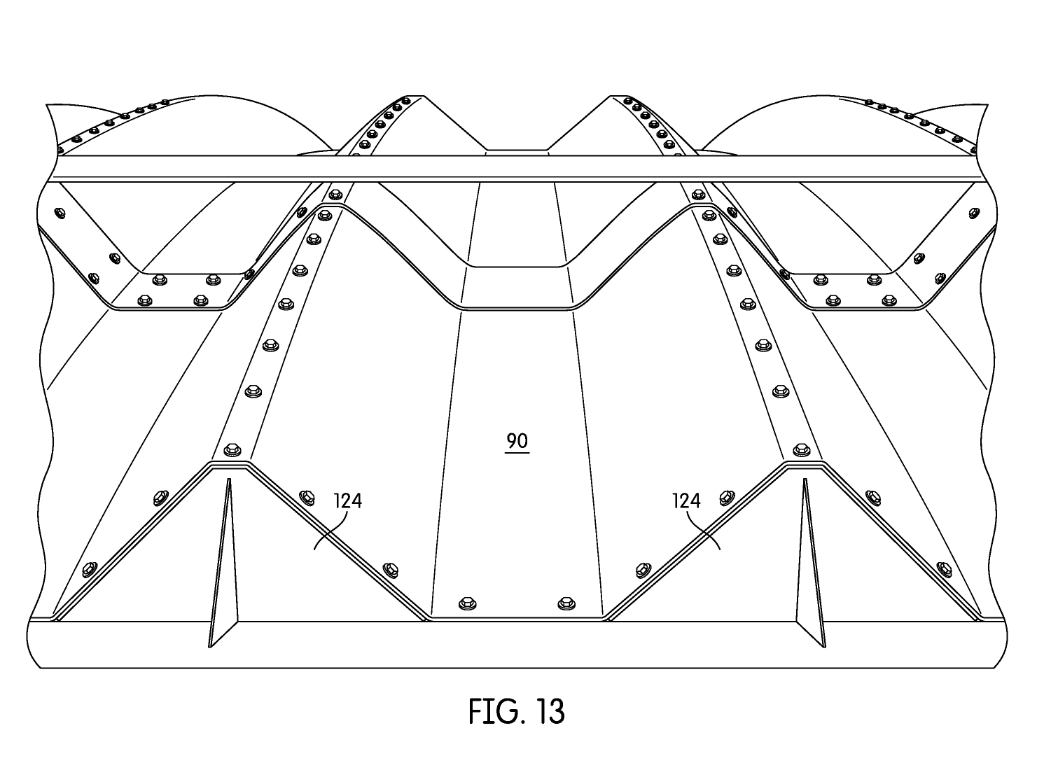

FIG. 13 shows an embodiment of the roof of the confinement section 40 (as well as the intake section 20). The roof is formed from overlapping gull-wing panels 90 secured to one another by suitable fasteners and formed into a desire arch. At the edges of the roof, the panels are secured to the side walls by means of panel connecting flanges conforming to the shape of the panels 90 and attached to the top of the top beam 110 of the curtain wall 54 at the desired orientation corresponding to the curvature of the roof The panels are bolted or riveted at their ends to the panel connecting flanges. In one embodiment, the panels are preassembled and then installed at opposed ends to the curtain wall 54, thereby forming the curvature of the roof depending on the length of the roof panel and the width of the building between the opposed curtain walls. End caps 124 in the shape of a truncated triangle seal off the opened ends of the panels 90 at the eave lines of the roof.

Suitable materials for the beams 110 and panels 90 include Galvalume®.

A plurality of hydraulic jacks 56 extend between the eaves of the roof 46 and the ground, preferably supported on the footing 52. The roof 46 and curtain wall 54 are capable of being lifted on the hydraulic jacks 56 between a “down” position supported on the perimeter walls 50, as shown in FIGS. 1(a), 4, 5, and 7(a) or on the footing 52 as shown in FIG. 9a, and an “up” position raised above the perimeter walls 50, as shown in FIGS. 1(b), 3, 6, and 7(b). As shown in FIGS. 7A and 8A, the difference in height between the down position and the up position can be three feet, which is exemplary and not intended to be limiting. In one embodiment, pole guide supports 130 are provided along both sides of the confinement section between the jacks 56. In one embodiment, the pole guide supports 130 and the jacks 56 are alternated every 15 feet along the lengths of both sides of the confinement section 40. In one embodiment two hydraulic jacks 56 are arranged opposite each other on opposed sides of the confinement section 40 at the intake end 42 and the exhaust end 44 of the section, and between the intake end 42 and exhaust end 44 of the section 40 the jacks 56 and the pole guide supports 130 are staggered so that each jack is positioned opposite a pole guide support on the opposed side of the section 40. In certain embodiments, pole guide supports 130 may be omitted.

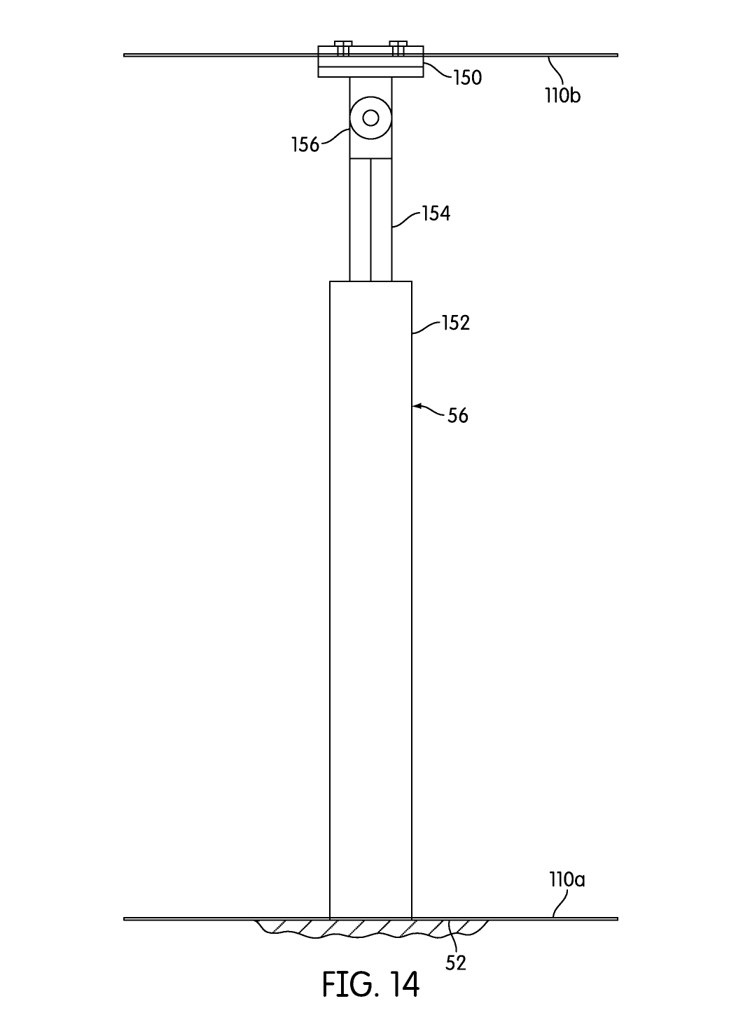

Details of each hydraulic jack 56 installation are schematically shown in FIG. 14. Each jack 56 comprises a cylinder 152 and a piston having a piston rod 154 extending from the cylinder 152. The lower end of the cylinder 152 is supported on the footing 52, and the upper end of the piston rod 154 is secured to the upper beam 110b by means of a clevis attachment 156 and a mounting pad 150 secured to the upper beam 110b. Note that the panels 90 of thee curtain wall 54 are omitted in FIG. 14 for clarity. The clevis attachment 156 provides a degree of rotational freedom to thereby permit some flexure between the upper beam 110b and the lower beam 110a. In addition, to disconnect the jack 56 for repair or replacement merely requires removal of the pin of the clevis attachment 156. The cylinder 152 of the jack 56 fits through an opening formed in the lower beam 110a. Accordingly, as the piston rod 154 extends to lift the roof 46, the curtain wall 54 elevates with the roof 46 over the jack 56.

Suitable hydraulic jacks 56 include model MH (ME4) cylinders with a 1⅜ inch piston rod by Sheffer Hydraulic.

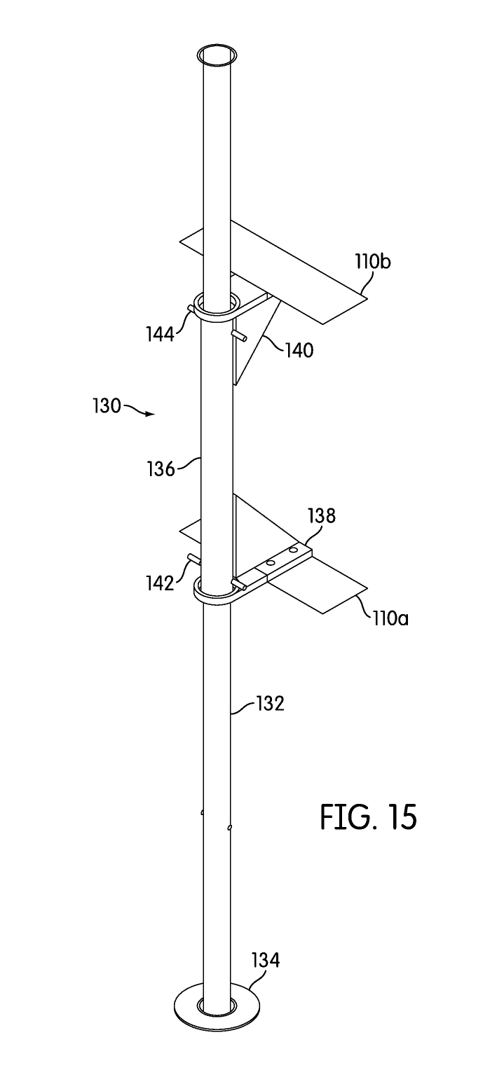

Details of a pole guide support 130 are shown in FIG. 15. Each pole guide support 130 includes a guide pole 132 having a foot plate 134 at its lower end that is supported on (and bolted to) or embedded in the footing 52 to hold the guide pole in a fixed, preferably vertical orientation with respect to the footing 52. A guide tube 136 fits over the guide pole 132, and a lower mounting bracket 138 is secured to the lower end of the guide tube 136 and an upper mounting bracket 140 is secured to the upper end of the guide tube 136. The lower mounting bracket 138 is secured, e.g., by suitable fasteners, such as bolts, screws, rivets, or welds, to the top of the lower beam 110a of the curtain wall 54, and the upper mounting bracket 140 is secured, e.g., by suitable fasteners, such as bolts, screws, rivets, or welds, to the bottom of the upper beam 110b of the curtain wall 54. Note that the panels 90 of thee curtain wall 54 are omitted in FIG. 15 for clarity. An upper locking ping 144 and a lower locking pin 142 extend through aligned holes in the guide tube 136 and the guide pole 132 to lock the guide tube 136 with respect to the guide pole 132. Pins 142 and 144 may comprise ¾ inch bolts. When the roof 46 is in the lowered position, pins 144 and 142 can be inserted so that the guide pole supports 130 assist the hydraulic jacks 56 in holding the roof 46 down, for example in high wind conditions. Similarly, when the roof 46 is in the raised position, pins 144 and 142 can be inserted so that the guide pole supports 130 assist the hydraulic jacks 56 in holding the roof 46 up. During transition of the roof between raised and lowered positions, the pins 142 and 144 are removed so that guide tube 136 can slide in an axial direction relative to the guide pole 132. A relatively close tolerance between the guide tube 136 and the guide pole 132 limits relative lateral movement between the guide pole 132 and the guide tube 136. Thus, lateral movement of the upper and lower beams 110a and 110b of the curtain wall 54 attached to the guide tube 136 is limited. Excessive lateral movement of the roof 46 and curtain wall 54 can cause malfunctions of the hydraulic jacks 56.

The hydraulic jacks 56 are coordinated by computer controls, and the roof 46 and curtain walls 54 are lifted by the hydraulic jacks 56 (e.g., eleven on each side of the section 40). Computer control of the hydraulic jacks 56 configured to achieve coordinated movement to set points spaced at ¼ inch intervals for each of the jacks 56 permits the roof 46 and curtain walls 54 of the entire confinement section 40 to be lifted and lowered in a precisely-coordinated manner If the entire roof structure 46 was not lifted and lowered at a simultaneous rate from all jacks 56, this could cause twisting and buckling, and even fracture, of the roof system. In addition the hydraulic fluid system includes pilot valves (e.g., pilot valves by continental hydraulics) to prevent further movement of the piston rod 154 in the event of a loss of hydraulic pressure.

By way of example, in the “down” position, the roof is 3 feet off the floor at the outside, and the center is 6 feet off the floor. The low roof reduces the cubic volume of air in the confinement section to and reduced the transverse cross-section of the confinement section 40. Thus, owing to the Bernoulli effect, air drawn into the intake section 20 will accelerate as it flows into the reduced cross-sectioned confinement section 40. Accordingly, relatively high air flow rates (e.g., 1000 ft/min) can be achieved in the confinement section 40 without the need to draw air into the intake section 20 at those same high rates.

On the other hand, when the chickens, or other livestock, are to be harvested from the confinement section 40 or maintenance and/or cleaning are required in the confinement section 40, the roof 46 can be raised to allow workers and equipment to enter the confinement section 40.

The housing system 10 includes various safety features. Should air flow through the confinement section 40 be interrupted—for example by a power outage—while the housing is full of animals, the animals will be adversely affected (including death) in a matter of minutes if air flow is not resumed. Accordingly, back up power generators are provided for the fans. In addition, if the air flow is interrupted and operation of the fans cannot be resumed, the roof control system may be configured to automatically raise the roof to permit additional air inflow into the building. For example, referring to FIG. 9b, if the roof is only partially lifted, the seals on brackets 83 and 85 will not contact each other, thereby avoiding a seal between the interior wall 80 and the curtain wall 54 and thus allowing air to flow into the confinement section 40 at the sides. In addition, a small motor (e.g., a 5 hp gasoline engine) may be provided for operating the hydraulic pump so that the hydraulic jacks can be operated even if main power and back up power are interrupted.

While the present invention has been described and shown in considerable detail with reference to certain illustrative embodiments, those skilled in the art will readily appreciate other embodiments of the present invention. Accordingly, the present invention is deemed to include all modifications and variations encompassed within the spirit and scope of the following appended claims.

1. A housing for holding livestock comprising:
an air intake section having a height and a width defining a transverse, interior cross-sectional space;
one or more are intake fans configured to draw air into said air intake section; and
an animal confinement section having an intake end and an exhaust end and connected to said air intake section so that air drawn into said air intake section by said one or more fans flows through said animal confinement section from said intake end to said exhaust end,
wherein said animal confinement section has a width and a height defining a transverse, interior cross-sectional space,
wherein said animal confinement section is configured such that the height thereof may be varied between a first height, which, together with the width of the said animal confinement section, defines a first interior cross-sectional space, and a second height smaller than the first height and which, together with the width of the said animal confinement section, defines a second interior cross-sectional space, and
wherein the cross-sectional area of the second interior cross-sectional space is less than the cross-sectional area of the first interior cross-sectional space and less than the cross-sectional area of the interior cross-sectional space of said air intake section.

2. The housing of claim 1, further comprising one or more wet panels comprising water-soaked fabric disposed in front of said one or more fans to impart moisture to the air drawn into said intake section.

3. The housing of claim 1, wherein said one or more intake fans are disposed in an end wall at the exhaust end of said confinement section.

4. The housing of claim 1, wherein said animal confinement section has a width that is smaller than a width of said air intake section.

5. The housing of claim 1, wherein said one or more intake fans are controlled to operate on an intermittent and timed basis.

6. The housing of claim 1, wherein said animal confinement section further comprises a roof and side walls, wherein at least a portion of a side wall is immobile and wherein the roof and at least another portion of a side wall is a curtain wall that is attached to the roof, and wherein the roof and the portion of the sidewall attached thereto are movable with respect to the immobile portion of the sidewall.

7. The housing of claim 6, wherein said immobile portion of a side wall comprises a perimeter wall which is configured support said roof when said animal confinement section is at said second height.

8. The housing of claim 6, wherein an immobile portion of a side wall comprises an interior wall, wherein the side wall further comprises at least one guide rod secured to both the interior wall and the curtain wall.

9. The housing of claim 1, wherein when the height of said animal confinement section is between said first height and said second height, said animal confinement section is configured to allow additional air to flow into said animal confinement section.

10. The housing of claim 1, wherein said animal confinement section further comprises a plurality of hydraulic jacks along a first length and along a second length of said animal confinement section between said intake end and said exhaust end, wherein said hydraulic jacks are configured to vary said animal confinement section between said first height and said second height.

11. The housing of claim 10, wherein said animal confinement section further comprises a plurality of support guide poles along a first length and along a second length of said animal confinement section between said intake end and said exhaust end.

12. The housing of claim 11, wherein said hydraulic jacks and said support guide poles are staggered such that a hydraulic jack along the first length of said animal confinement section is positioned opposite a support guide pole along the second length of said animal confinement section, and such that a support guide pole along the first length of said animal confinement section is positioned opposite a hydraulic jack along the second length of said animal confinement section.

13. The housing of claim 1, further comprising a roof control system configured to automatically move the height of said animal confinement section to said first height when the air flow drawn into the housing at said air intake section is interrupted.

14. The housing of claim 2, further comprising:
sensors configured to measure one or more of flow rate, air temperature, and humidity of the airflow through said animal confinement section; and
a servo control system coupled to said sensors and configured to control one or more of said fans and said wet panels in response to measurements from said sensors to control one or more of the flow rate, air temperature, and humidity of the airflow through said animal confinement section.

15. The housing of claim 6, wherein said roof is comprised of gull-wing panels.

16. The housing of claim 1, wherein said housing is configured to provide a relatively unobstructed airflow path.

17. The housing of claim 8, wherein said interior wall is comprised of a material selected from the group of plywood, PVC, or Plexiglas.

18. The housing of claim 1, wherein the difference between said first height and said second height is about three feet.

19. The housing of claim 1, wherein the height of said animal containment section varies between said first height and said second height in one-quarter inch intervals.

20. The housing of claim 1, further comprising sensors configured to measure one or more of flow rate, air temperature, and humidity of the airflow through said animal confinement section.

21. The housing of claim 1, wherein the height of said animal containment section is defined as the distance between a ceiling of said animal confinement section and a floor of said animal confinement section.

22. The housing of claim 21, wherein the height of said animal confinement section is changed from said first height to said second height by moving the ceiling of said animal confinement section with respect to the floor of said animal confinement section from a first position relative to the floor of said animal confinement section to a second position relative to the floor of said animal confinement section that is closer to the floor of said animal confinement section than the first position.

23. The housing of claim 1, wherein the height of said animal containment section is defined as the distance between a ceiling of said animal confinement section and a ground level.

24. The housing of claim 1, wherein the height of said animal confinement section is changed from said first height to said second height by moving a ceiling of said animal confinement section from a first position to a second position that is lower than the first position.

25. A housing for holding livestock comprising:
an air intake section having a height and a width defining a transverse, interior cross-sectional space;
one or more are intake fans configured to draw air into said air intake section; and
an animal confinement section having an intake end and an exhaust end and connected to said air intake section so that air drawn into said air intake section by said one or more fans flows through said animal confinement section from said intake end to said exhaust end,
wherein said animal confinement section has a width and a distance between a ceiling and a floor of the said animal confinement section defining a transverse, interior cross-sectional space, and
wherein said animal confinement section is configured such that the distance between the ceiling and the floor of the said animal confinement section thereof may be varied between a first distance between the ceiling and the floor of the said animal confinement section, which, together with the width of the said animal confinement section, defines a first interior cross-sectional space, and a second distance between the ceiling and the floor of the said animal confinement section smaller than the first distance between the ceiling and the floor of the said animal confinement section and which, together with the width of the said animal confinement section, defines a second interior cross-sectional space,
wherein the cross-sectional area of the second interior cross-sectional space is less than the cross-sectional area of the first interior cross-sectional space and less than the cross-sectional area of the interior cross-sectional space of said air intake section.
